(19) United States
(12) Patent Application Publication
(10) Pub. No.: US 2015/0086201 A1
(43) Pub. Date: Mar. 26, 2015

(54) Data Multiplexing And Mixing Of Optical Signals Across Propagation Modes

(71) Applicant: Alcatel-Lucent USA Inc., Murray Hill, NJ (US)

(72) Inventors: Roland Ryf, Aberdeen, NJ (US); René-Jean Essiambre, Red Bank, NJ (US); Alan Gnauck, Middletown, NJ (US)

(73) Assignee: Alcatel-Lucent USA Inc., Murray Hill, NJ (US)

(21) Appl. No.: 14/033,126

(22) Filed: Sep. 20, 2013

(51) Int. Cl. H04B 10/58; H04J 14/04; H04B 10/2507

(52) U.S. Cl. CPC H04B 10/58; H04B 10/2507; H04J 14/04
USPC 398/44

(57) ABSTRACT

An apparatus, e.g. an optical device, includes an optical transmitter and a mixer. The transmitter is configured to transmit a plurality of optical data channels that each include at least one spectral component at a same frequency. The mixer is configured to combine a first data channel with a second data channel. The combining is such that first and second optical channels output by the optical transmitter each include contributions from the first and second data channels at the same frequency.

### TECHNICAL FIELD

The disclosure relates generally to the field of optical communications.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Optical fiber nonlinearity may result in degradation of signal fidelity in optical communications systems. Single-mode optical fibers with large effective areas can provide some improvement in nonlinear transmission, but these systems remain limited by fiber nonlinearity. Multicore and multimode fibers can provide additional capacity or reach, but these systems also remain limited by fiber nonlinearity.

### SUMMARY

One embodiment provides an apparatus, e.g. an optical device, that includes an optical transmitter and a mixer. The transmitter is configured to transmit a plurality of optical data channels, each including a spectral component at a same frequency. The mixer is configured to combine a first data channel with a second data channel. The combining is such that first and second optical channels output by the optical transmitter each include contributions from the first and second data channels at the same frequency. In some embodiments of the apparatus a multiple-input-multiple-output (MIMO) module is configured to recover the data channels from the output optical signals.

In some embodiments of the apparatus the mixer is configured to optically mix the contributions. In some embodiments the mixer includes an optical coupler having M inputs and N outputs, and is configured to map M optical signals, corresponding to each of the data channels and received at corresponding ones of the M inputs, among N output signals. In some such embodiments M=N. In other such embodiments the mixer is configured to apply a non-equal weighting to each of the N output signals.

In some embodiments of the apparatus the mixer includes a mode scrambler. The mode scrambler is configured to remap a plurality of optical signals to a different corresponding optical propagation mode, with each optical signal being received via a corresponding optical propagation mode. In some embodiments of the apparatus the mixer is one of a plurality of optical mixers, with each optical mixer of the plurality having inputs and outputs. In such embodiments each optical mixer is configured to impose a corresponding mixing function on optical signals received at inputs thereof. In some such embodiments the mixing functions are a same mixing function.

In some embodiments of the apparatus the mixer is optically coupled to a spatially diverse optical medium and is configured to propagate the output optical signals into a corresponding plurality of spatially diverse optical paths of the optical medium.

In some embodiments the mixer is configured to electrically mix the contributions. In some such embodiments the mixer is configured to provide a unitary transformation between the electrical signals. In other such embodiments the mixer is configured to provide an invertible linear transformation of the electrical signals. In some embodiments an inverse transformation module is configured to apply an inverse of the unitary transformation after coherent detection of the first and second optical channels.

Another embodiment provides a method, e.g. for reducing the effect of nonlinearities of optical path on data channels propagated via the optical paths. The method includes configuring a signal mixer to receive a plurality of data channels at a plurality of inputs. The method further includes configuring the signal mixer to impose a mixing function on the data channels such that data received at each of the inputs is distributed among output optical signals at the plurality of outputs. The method further includes configuring an optical modulator to modulate an optical signal corresponding to each data channel.

In some embodiments, the method includes configuring a multiple-input-multiple-output (MIMO) module to recover the data channels from the output optical signals. In some embodiments the method includes configuring the output optical signals to propagate via a spatially diverse optical medium.

Some embodiments of the method include configuring an optical mixer to operate as the signal mixer. The optical mixer includes an N×N optical coupler configured to map N received optical signals among N outputs with a predetermined weighting. In some such embodiments the method includes configuring the optical mixer to remap a plurality of optical signals, each signal being received via a corresponding optical propagation mode, to a different corresponding propagation mode.

Some embodiments of the method include configuring an electrical mixer to operate as the signal mixer. The electrical mixer is configured to receive a plurality of electrical data channels at the plurality of inputs. The electrical mixer is further configured to impose a mixing function on the electrical data channels such that data received at each of the inputs is distributed among output electrical signals at the plurality of outputs. The electrical mixer is still further configured to provide each of the output electrical signals to an optical modulator.

### BRIEF DESCRIPTION OF THE DRAWINGS

A more complete understanding of the present invention may be obtained by reference to the following detailed description when taken in conjunction with the accompanying drawings, wherein:

FIG. 1 illustrates an embodiment, e.g. a system, in which an optical mixer mixes a plurality of optical channels after optical modulation of the channels, e.g. to reduce the effect of optical channel nonlinearities;

FIGS. 2A-2C illustrate embodiments of transmission media that may be used, e.g. in the embodiments of FIGS. 1 and 4, including N single-mode optical fibers (FIG. 2A), multi-core optical fibers with uncoupled cores (FIG. 2B), and multi-mode optical fibers (FIG. 2C);

FIG. 3 illustrates an embodiment of the optical mixer of FIG. 1, implemented as an N×N optical coupler;

FIG. 4 illustrates an embodiment, e.g. a system, in which an electrical mixer mixes a plurality of data channels prior to optical modulation of a corresponding number of optical channels;

FIG. 5 illustrates an embodiment of the electrical mixer of FIG. 4, implemented including a processor, memory and I/O module; and

FIG. 6 illustrates an embodiment, e.g. a system, that provides multistage mixing of optical channels, e.g. to further reduce the effect of optical channel nonlinearities.

### DETAILED DESCRIPTION

The disclosure is directed to, e.g. methods and systems for distributing transmitted optical data among two or more optical fiber channels, such that, e.g., the effect of transmission nonlinearities of the fiber channels on the integrity of transmitted data is reduced.

The impact of nonlinear distortions on the performance of fiber-optic communication systems caused by optical path nonlinearity is thought to depend on the spatial diversity of propagated waveforms, e.g. how the waveforms are distributed among multiple parallel optical paths. Moreover the distribution of the distortions across the data channels to be transmitted is also expected to affect system performance.

Embodiments described herein may mitigate the adverse performance impact caused by these distortions by combining in a transmitter data channels, e.g. first and second data channels, such that optical channels output by the transmitter include contributions from each of first and second data channels. In other words, each data channel is transmitted in parallel among the multiple optical channels. The optical channels are then propagated by corresponding spatially diverse optical paths. The combining, or mixing, distributes the transmitted information among the optical paths in a manner that is expected to average out nonlinear distortions over the data channels. The averaging is expected to reduce the effect of the distortions on the data recovered from the optical channels, e.g. by multiple-input multiple-output (MIMO) processing. In various embodiments a transformation is applied to the data channels in a manner that distributes the channels across all propagating modes. Such embodiments are expected in at least some cases to result in the greatest benefit for a particular system configuration.

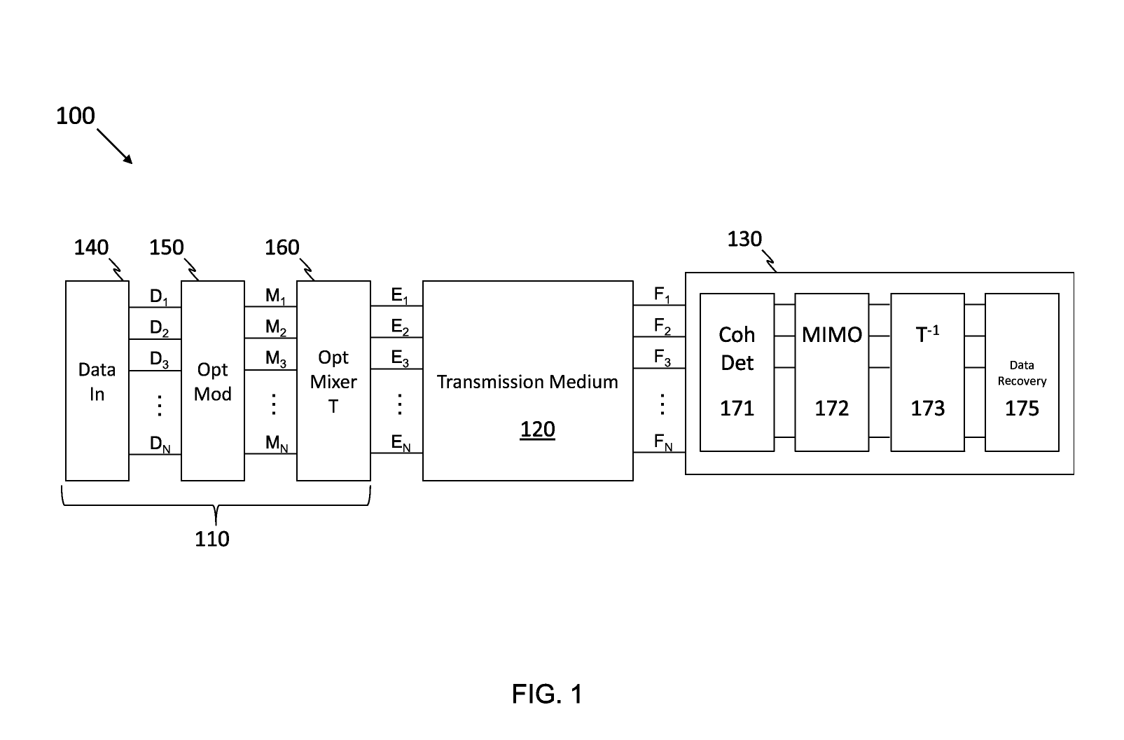

Turning to FIG. 1, a system 100 is illustrated according to one embodiment. The system 100 includes a transmitter 110, a transmission medium 120, and a receiver 130. The transmitter 110 includes a data source 140, an optical modulator 150, and a mixer 160, e.g. an optical mixer. The data source 140 may be any source of data configured to provide a plurality of data channels D₁ . . . D_{N}. The data channels include digital-electrical data representations of data values. The optical modulator 150 receives the data signals at corresponding inputs and modulates a plurality of optical signals corresponding to the data signals, thereby producing modulated optical signals M₁ . . . M_{N}. The optical modulator 150 may include such components as, e.g., digital-to-analog converters, lasers and Mach-Zehnder modulators. The optical channels may be modulated according to any type of modulation scheme, for example and without limitation, on-off keying (OOK), differential phase shift keying (DPSK), quaternary phase shift keying (QPSK), or quadrature amplitude modulation (QAM) format with or without return to zero or nonreturn to zero pulse shaping. Moreover, additional multiplexing schemes may be used to increase the signal capacity, for example and without limitation polarization-division multiplexing (PDM), wavelength-division multiplexing (WDM), or orthogonal frequency-division multiplexing (OFDM).

The mixer 160 receives the modulated optical signals and applies a transformation T thereto, as described further below, thereby producing transformed optical signals E₁ . . . E_{N}. The optical transmission medium 120 receives the transformed optical signals, which are propagated via multiple parallel spatially diverse paths. As used herein, spatially diverse paths are optical propagation paths or modes having nominally substantially orthogonal basis sets such that, absent nonlinear effects, there is negligible coupling between any two of the spatially diverse paths. However, as described further below, under some conditions nonlinear effects may become non-negligible, with resulting non-negligible coupling between spatially diverse paths.

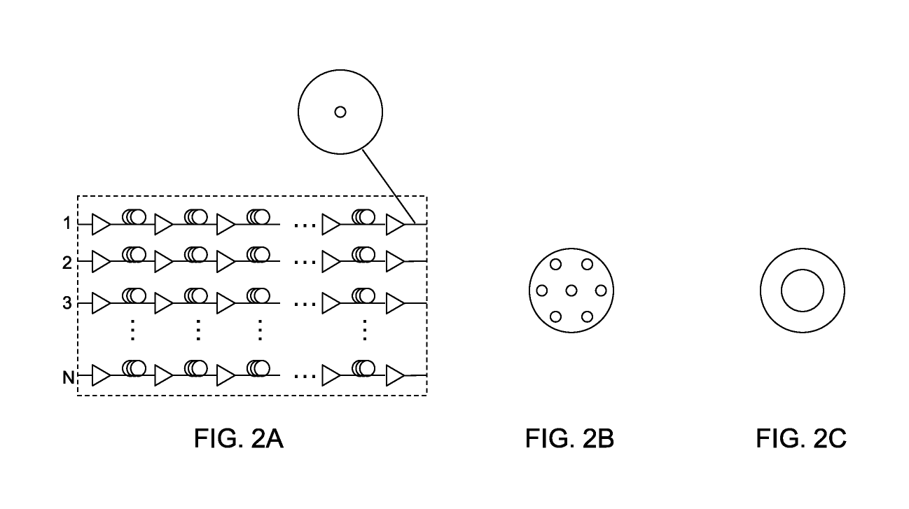

FIGS. 2A-2C present three nonlimiting illustrative embodiments of the medium 120. FIG. 2A illustrates N single-mode fibers (SMFs) that may collectively serve as the medium 120. Each single-mode fiber may operate to support an optical propagation mode, the optical propagation modes of the multiple fibers being spatially diverse propagation modes. FIG. 2B illustrates a single fiber having a plurality of N (N=7) optical cores, e.g. a multi-core fiber (MCF). Each of the optical cores may operate to support an optical propagation mode, the optical propagation modes of the multiple cores being spatially diverse propagation modes. FIG. 2C illustrates a single fiber having a single optical core capable of supporting a plurality of N propagation modes, e.g. a multi-mode fiber (MMF). The propagation modes of the multi-mode fiber may also considered to be spatially diverse propagation modes. As used herein, the term “spatially diverse optical medium” is inclusive of the N SMFs, the N-core MCF, and N-mode MMF. Each of the optical cores and/or propagation modes of the spatially diverse optical medium may be referred to herein and in the claims as one of a plurality of spatially diverse optical paths. The value of N may correspond to, e.g., the number of spatial modes, the number of vector modes or the number of signal quadratures (such as in coherent optical transmission), according to the context.

Returning to FIG. 1, each of the optical signals output by the optical modulator 150 may include multiple spectral components λ₁, λ₂ . . . λₖ, e.g. may be wavelength-division multiplexed (WDM) signals. One or more of the spectral components may be organized in one or more superchannels. In some embodiments the outputs may each include one or more same spectral components, e.g. data channels modulated to a same wavelength channel of the WDM signals. The mixer 160 imposes a transformation on the optical signals output by the optical modulator 150. The transformation distributes the optical channels among the plurality of optical paths. The selection of the transformation may depend on the nature of the medium 120, as further discussed below. The mixing has the effect of superimposing portions of the received optical signals at one or more same wavelengths of the optical channels. For example, two or more of the signals M₁ . . . M_{N} may include modulated data on the λ₁ channel of each respective WDM signal. The mixer 160 provides at each of its outputs a portion of the λ₁ signal received via signal M₁, a portion of the λ₁ signal received via signal M₂, a portion of the λ₁ signal received via signal M₃, and so on. In this manner, the spectral components at each frequency of each output of the optical modulator 150 may be mixed with each other at each output of the mixer 160. Each mixed signals are then coupled to a corresponding spatially diverse optical path of the medium 120.

The medium 120 may impose a distortion signal on the optical signals E₁ . . . E_{N}. The distortion signal may be, e.g. a nonlinear distortion due to intrinsic nonlinearities in the propagation characteristics of the medium 120. The distortion caused by such nonlinearity in an optical path may be greater for a higher power level of the optical signal propagating within the optical path. The distorted optical signals after propagation by the medium 120 are designated F₁ . . . F_{N} to reflect the added distortion signal.

The receiver 130 receives the signals F₁ . . . F_{N}, and includes a coherent detector 171, a MIMO module 172 and a data recovery module 175 The coherent detector 171 provides well-known optical and electrical functionality to convert the optical F₁ . . . F_{N} signals to electrical domain. In a manner analogous to radio frequency (RF) MIMO processing, the MIMO module 172 may apply conventional or novel processing algorithms to account for the spatial separation of the propagated data channels among the propagation paths of the medium 120. Some aspects of MIMO processing of optical signals are described in Sebastian Randel, et al., “6×56-Gb/s mode-division multiplexed transmission over 33-km few-mode fiber enabled by 6×6 MIMO equalization,” Opt. Express 19, 16697-16707 (2011), incorporated herein by reference. The data recovery module 175 applies additional computational resources to recover the D₁ . . . D_{N} signals from the output by the MIMO module 172. Some embodiments include an inverse transformation module 173 configured to apply an inverse transformation, e.g. an inverse T⁻¹ of the transformation T applied by the optical mixer 160. One or more of the MIMO module 172, data recovery module 175 and the transformation module may be provided by a fixed or reconfigurable computational device such as, e.g. a digital signal processor (DSP).

Because the data of a particular data channel has propagated via multiple propagation paths and/or modes, the nonlinearity associated with any particular one of the paths and/or modes is expected to be reduced due to an averaging effect. This averaging effect is expected to improve the overall transmission fidelity of the system 100, as measured by, e.g., a reduced bit error rate (BER). Moreover, this improvement is expected to advantageously allow transmission through the medium 120 with a greater optical power level than would otherwise be possible for a given target BER.

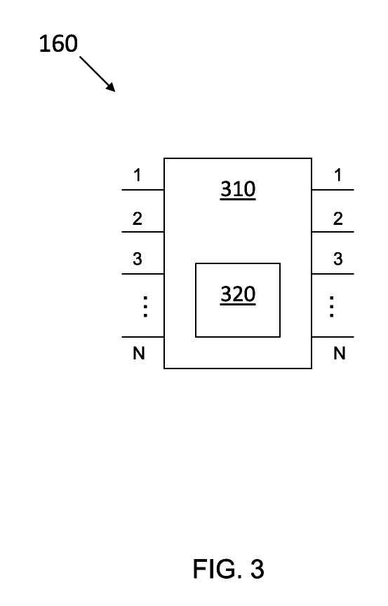

FIG. 3 illustrates one embodiment of the mixer 160. The mixer 160 may include, e.g. an N×N optical coupler or a mode scrambler. In the illustrated embodiment, the mixer 160 includes a N×N optical coupler 310. While N is not limited to any particular value, in some such embodiments the optical coupler 310 may be a 3×3 optical coupler (N=3). Those skilled in the pertinent art will appreciate that an N×N optical coupler may distribute portions of the optical energy received at each input among each of the outputs according to specific relationships. Of course, the mixer 160 is not limited to using a 3×3 optical coupler. In some embodiments the number of inputs and outputs of an optical coupler used to implement the mixer 160 may be unequal, e.g. M inputs and N outputs. In some embodiments the weighting of the distribution of one or more inputs to the outputs may be equal, while in other embodiments the weighting may be unequal.

In some embodiments the optical mixer 160 may include a mode scrambler 320. As appreciated by those skilled in the pertinent art, a mode scrambler may be used to produce mode coupling between different optical modes of propagating signals. The mixer 160 may also include whatever additional optical functionality is needed to couple the N outputs to a corresponding number of spatially diverse propagation modes of the transmission medium 120. Such functionality may include any combination of, e.g. mirrors, beam splitters, mode couplers, planar waveguide circuits, multimode interferometers, and 3D-waveguide mode adapters and sorters.

In some other embodiments, not shown, data channel mixing may be provided by a multichannel optical component such as, e.g. a few-mode fiber erbium-doped fiber amplifier (EDFA) in a transmission medium that does not exhibit any inherent mixing. In other embodiments, the channel mixing may be provided by combining a section of a propagation medium (e.g. optical fiber) that inherently provides channel mixing with sections of various media that are not characterized by inherent mixing.

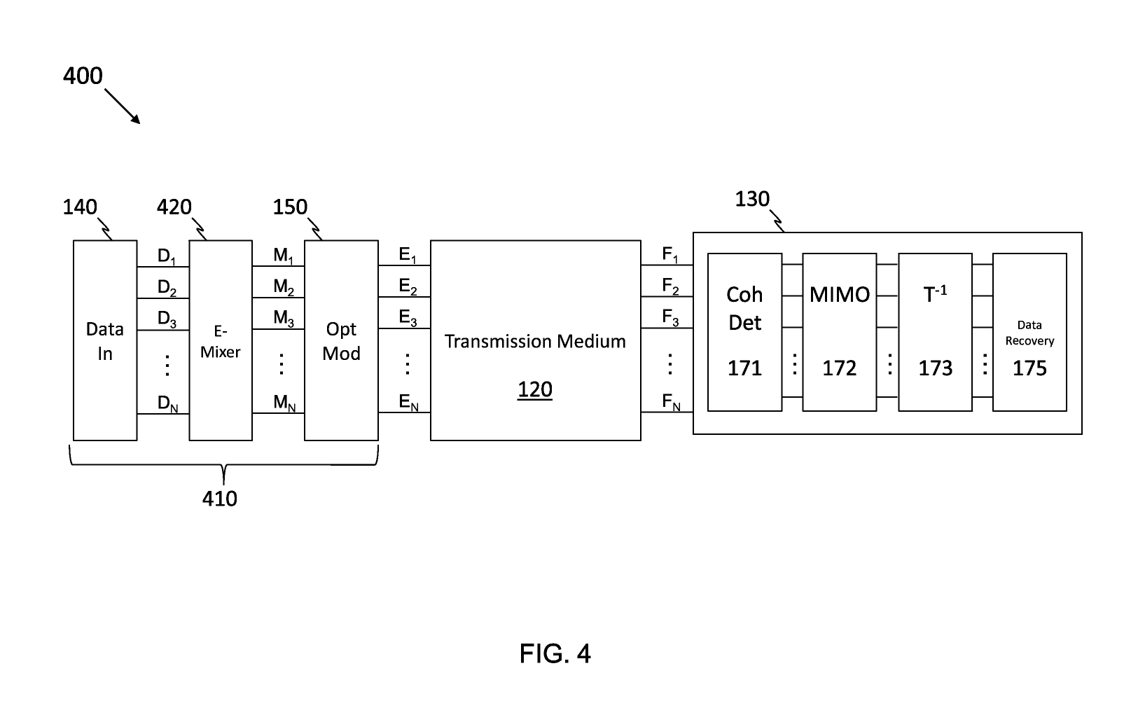

Turning to FIG. 4, a system 400 is illustrated according to another embodiment. In the system 400 a transmitter 410 includes an electrical-domain mixer 420. The mixer 420 receives the data channels D₁ . . . D_{N} at corresponding inputs, and electrically applies a mixing function to the data channels such that data received at each of the inputs is distributed among output electrical signals at a plurality of outputs of the mixer 420.

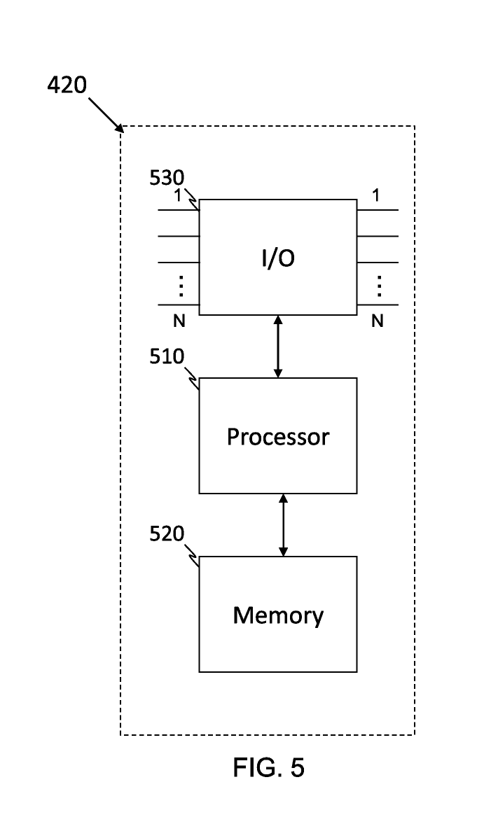

FIG. 5 illustrates without limitation a representative embodiment that may implement the mixer 420. In the illustrated embodiment a processor 510 is operatively coupled to a memory 520 and an I/O module 530. The processor 510 may be or include a microprocessor, application-specific integrated circuit (ASIC), digital signal processor (DSP), finite state machine, or any other similar subsystem capable of implementing a fixed or reconfigurable instruction set. The memory 520 may store a fixed or reconfigurable instruction set that is executed by the processor 510. The I/O module 530 is controllable by the processor to receive the D₁ . . . D_{N} inputs, and to provide the M₁ . . . M_{N} outputs. While shown as a separate entity, the memory 520 and/or the I/O module 530 may in some cases be integrated with the processor 510 on a common semiconductor substrate. Similar to the optical-domain mixer 160, the electrical-domain mixer 420 may also have an unequal number of inputs and outputs, e.g. M×N.

In some embodiments the mixer 420 may be configured to perform a unitary transformation between the received data D₁ . . . D_{N} and the output data M₁ . . . M_{N}. As appreciated by those skilled in the pertinent art, a unitary transformation may provide a linear transformation of basis modes of the input data. In such a transformation, the input data may be mixed without loss of information. The unitary transformation may implemented at the spatial mode, vector mode or signal quadrature levels. Moreover the unitary transformation may also be implemented in the time domain, for instance by introducing multiple time delayed copies of signal portions. In some cases it may be preferable to implement a unitary transformation for which the power content originated from each of the data D₁ . . . D_{N} at each of the spatial outputs M₁ . . . M_{N} is about equal, though this feature is not required to realize the benefits of the described embodiments. Those skilled in the pertinent art are able to determine such functions without undue experimentation.

In some embodiments the mixer 420 may implement an invertible linear transformation in spatial modes and time. Those skilled in the pertinent art are familiar with such linear transformations. As a non-limiting example, multiple cascaded rotation matrices can be used to mix signals in a reversible way. In some embodiments the transformation is selected according to the nature of the medium 120. For example the transmission medium may include heterogeneous data channels, such as, for example, embodiments in which the transmission medium includes multiple fibers having different effective areas.

Returning to FIG. 4, the optical modulator 150 receives the output of the mixer 420, and produces therefrom the mixed optical signals E₁ . . . E_{N}. After these optical signals propagate via the medium 120, the MIMO module 170 receives the distorted optical signals F₁ . . . F_{N} and operates as previously described with respect to FIG. 1. In this case, the recovery algorithm may be designed to take into account the specific transformation applied by the mixer 420, for example by applying an inverse of the transformation applied by the mixer 420.

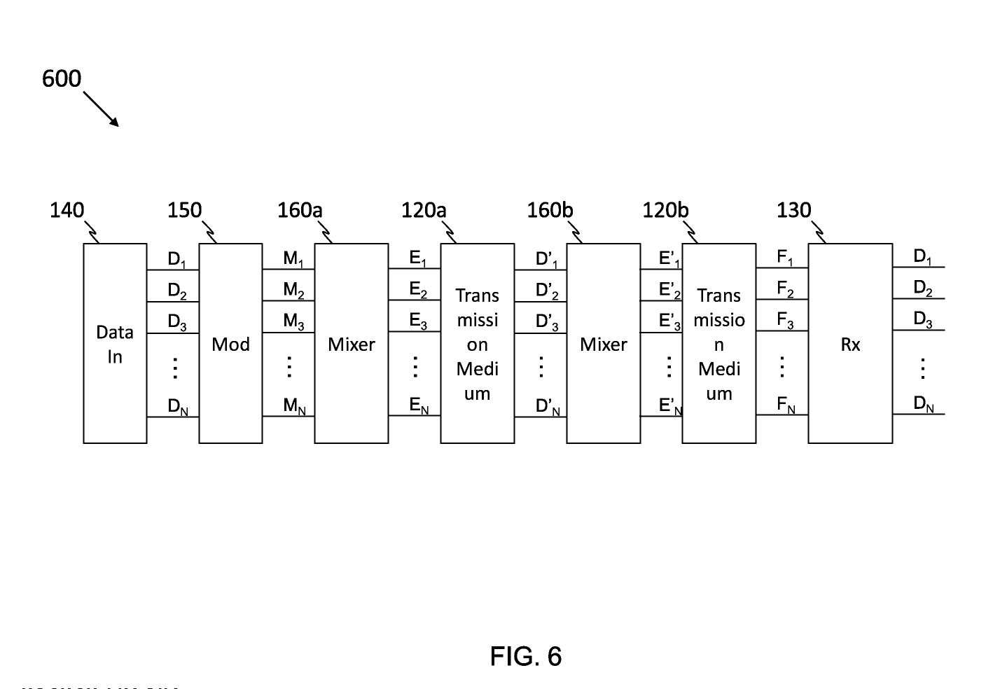

FIG. 6 illustrates an embodiment, e.g. a system 600, which includes multiple instances of the mixer 160. A first instance 160a of the mixer receives the output of the optical modulator 150 and provides first transformed signals E₁ . . . E_{N} to a first instance 120a of the transmission medium. A second instance 160b of the mixer receives intermediate propagated signals D′₁ . . . D′_{N} from the transmission medium 120a and applies a second transformation to the received data to produce second transformed signals E′₁ . . . E′_{N}. A second instance 120b of the transmission medium 120b propagates the signals E′₁ . . . E′_{N} to produce final propagated signal F₁ . . . F_{N}. The receiver 130 then operates as previously described to recover the data D₁ . . . D_{N}. Such multiple placements of the optical mixer 160 is expected in some circumstances to provide additional mixing of the spatial modes at various transmission distances, and therefore further improve performance of the optical transmission system relative to the embodiments of FIGS. 1 and 2. While the configuration of the system 600 is described for the case that the mixing is performed in the optical domain, in other embodiments the mixing is performed in the electrical domain. Those skilled in the pertinent art can easily determine the configuration of such embodiments based on the principles described herein.

Although multiple embodiments of the present invention have been illustrated in the accompanying drawings and described in the foregoing detailed description, it should be understood that the present invention is not limited to the disclosed embodiments, but is capable of numerous rearrangements, modifications and substitutions without departing from the invention as set forth and defined by the following claims.

1. An apparatus, comprising:
an optical transmitter configured to transmit a plurality of optical data channels each including at least one spectral component at a same frequency; and
a mixer configured to combine a first data channel with a second data channel such that first and second optical channels output by the optical transmitter each include contributions from the first and second data channels at said same frequency.

2. The apparatus of claim 1, wherein said mixer is configured to optically mix the contributions.

3. The apparatus of claim 1, wherein the mixer includes an optical coupler having M inputs and N outputs and configured to map M optical signals, corresponding to each of the data channels and received at corresponding ones of the M inputs, among N output signals.

4. The apparatus of claim 3, wherein M=N.

5. The apparatus of claim 3, wherein the mixer is configured to apply a non-equal weighting to each of the N output signals.

6. The apparatus of claim 1, wherein the mixer includes a mode scrambler configured to remap a plurality of optical signals, each optical signal being received via a corresponding optical propagation mode, to a different corresponding optical propagation mode.

7. The apparatus of claim 1, wherein said mixer is one of a plurality of optical mixers, each optical mixer of said plurality having inputs and outputs, and each optical mixer being configured to impose a corresponding mixing function on optical signals received at inputs thereof.

8. The apparatus of claim 7, wherein the mixing functions are a same mixing function.

9. The apparatus of claim 1, further comprising a multiple-input-multiple-output (MIMO) module configured to recover the data channels from the output optical signals.

10. The apparatus of claim 1, wherein the mixer is optically coupled to a spatially diverse optical medium and configured to propagate the output optical signals into a corresponding plurality of spatially diverse optical paths of the optical medium.

11. The apparatus of claim 1, wherein said mixer is configured to electrically mix the contributions.

12. The apparatus of claim 11, wherein the mixer is configured to provide a unitary transformation between the electrical signals.

13. The apparatus of claim 11, wherein the mixer is configured to provide an invertible linear transformation of the electrical signals.

14. The apparatus of claim 12, further comprising an inverse transformation module configured to apply an inverse of the unitary transformation after coherent detection of the first and second optical channels.

15. A method, comprising:
configuring a signal mixer to:
receive a plurality of data channels at a plurality of inputs; and
impose a mixing function on the data channels such that data received at each of said inputs is distributed among output optical signals at said plurality of outputs; and
configuring an optical modulator to modulate an optical signal corresponding to each data channel.

16. The method of claim 15, wherein the mixer is an optical mixer that includes an N×N optical coupler configured to map N received optical signals among N outputs with a predetermined weighting.

17. The method of claim 16, further comprising configuring the optical mixer to remap a plurality of optical signals, each signal being received via a corresponding optical propagation mode, to a different corresponding propagation mode.

18. The method of claim 15, wherein the mixer is an electrical mixer configured to:
receive a plurality of electrical data channels at said plurality of inputs;
impose a mixing function on the electrical data channels such that data received at each of said inputs is distributed among output electrical signals at said plurality of outputs; and
provide each of the output electrical signals to an optical modulator.

19. The method of claim 15, further comprising configuring a multiple-input-multiple-output (MIMO) module to recover the data channels from the output optical signals.

20. The method of claim 15, further comprising configuring a spatially diverse optical medium to receive the output optical signals.
